(19) United States
(12) Patent Application Publication
(10) Pub. No.: US 2004/0197076 A1
(43) Pub. Date: Oct. 7, 2004

(54) Image processing method

(76) Inventors: Ching-Te Tseng, Hsinchu City (TW); Chang-Hung Lee, Yunlin (TW); Yi-Lon Chin, Yonghe City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/802,371

(22) Filed: Mar. 17, 2004

(30) Foreign Application Priority Data
Apr. 3, 2003 (TW) 92107599

(51) Int. Cl. H04N 5/76; H04N 5/781

(52) U.S. Cl. 386/46; 386/125

(57) ABSTRACT

An image processing method able to maintain the image display quality of a transmitting system during a channel conversion from a first channel to a second channel. A first image signal and a second image signal are respectively transmitted to the transmitting system from the first channel and the second channel. A channel conversion request is sent to the transmitting system, controlling the transmitting system to stop transmitting the first image signal and start transmitting a preset image signal. Finally, the preset image signal stops transmitting, and the second image signal starts transmitting.

### BACKGROUND OF THE INVENTION

1. Field of the Invention

The present invention relates to an image processing method, and more particularly to an image processing method whereby the image display quality is ensured during a channel-conversion operation.

2. Description of the Related Art

According to the Federal Communications Commission (FCC) of the U.S., a Digital Television (DTV) is a new type of broadcasting technology that will transform television. The DTV technology will allow broadcasters to offer television with movie-quality picture and CD-quality sound, along with a variety of other enhancements. The DTV technology can also be used to transmit large amounts of other data into the home, which may be accessible by using a computer or television set.

DTV technology requires a transmitting system that digitizes signals for transmission and reception, and a DTV must be provided to receive the digitized signals. FIG. 1a illustrates a conventional DTV receiver. An image signal is received by an antenna 104, decoded by an image-decoding device 108, and then displayed on a display device 110. An infrared receiving device 106 is for receiving control signals transmitted from an infrared remote controller 102.

FIG. 1b illustrates a conventional transmitter of a DTV. A tuner 114, coupling to a cable line 112, is for channel conversion. An image-encoding device 116 digitizes an image signal transmitted from the cable line 112, and compresses the digitized image signal by a certain compression method. The compressed digitized image signal is then transmitted by an antenna 118.

The receiver of FIG. 1a and the transmitter of FIG. 1b (i.e. a physical layer, PHY) communicate via the 802.11b protocol, while a software layer transmits information via the user datagram protocol (UDP).

After a user sends instructions by the infrared remote controller 102 to the receiver to ask the transmitter for channel conversion, the images of a previous channel are combined with the images of a current channel for a period of time. In addition, due to the channel conversion, the image signals are asynchronous and unstable, thus adversely affecting the image display quality.

The channel conversion request will not seriously reduce image display quality if the image signals are transmitted via cable. If the image signals are transmitted wirelessly, however, image display quality suffers greatly. During wireless transmission, the image signals are usually compressed in advance by a “group of pictures, (GOP)” compression technique. With MPEG4, a compression technique developed by the Moving Picture Experts Group (MPEG), for example, an image I is set to be the most important image in a group of pictures, and the image I can include all information of a previous picture, while images P and B coming after the image I include only the information regarding the deviation between the previous picture and the later pictures. If the group of pictures is large, a large amount of redundant image data can be eliminated from the transmission, thus offering better compression. If, however, the group of pictures is too large, image I and the later images P and B might have image signals of different channels during channel conversion, resulting in a huge deviation between previous and later images and reduced image display quality.

### SUMMARY OF THE INVENTION

Accordingly, an object of the present invention is to provide an image processing method whereby the image display quality is ensured during a channel-conversion operation.

Accordingly, another object of the present invention is to provide a transmitting system whereby the inventive image-processing method is employed, and the image display quality is ensured during a channel-conversion operation.

Therefore, the invention provides an image processing method able to maintain the image display quality of a transmitting system during a channel conversion from a first channel to a second channel, wherein a first image signal and a second image signal are respectively transmitted to the transmitting system from the first channel and the second channel. The image processing method comprises the steps of sending a channel conversion request to the transmitting system, controlling the transmitting system to stop transmission of the first image signal and start transmission of a preset image signal, and finally stopping transmission of the preset image signal, and starting transmission of the second image signal.

The invention further provides a transmitting system, which comprises a receiving module for receiving a channel conversion request, a tuner, a controlling device, and a storage device. The tuner is for channel conversion from a first channel to a second channel, wherein a first image signal and a second image signal are respectively transmitted to the transmitting system from the first channel and the second channel. The controlling device is used to control the tuner for channel conversion according to the channel conversion request, stopping transmission of the first image signal and transmitting the preset image signal instead, and starting transmission of the second image signal after stopping transmission of the preset image signal. The storage device is for storing the preset image signal.

### DESCRIPTION OF THE DRAWINGS

The present invention can be more fully understood by reading the subsequent detailed description and examples with references made to the accompanying drawings, wherein:

FIG. 1a illustrates a conventional receiver of a DTV;

FIG. 1b illustrates a conventional transmitter of a DTV;

FIG. 2 is a flow diagram showing the image processing method according to the first embodiment;

FIG. 3 illustrates a transmitting system applicable in the image method according to the first embodiment;

FIG. 4 is a flow diagram showing the image processing method according to the second embodiment;

FIG. 5 illustrates a transmitting system applicable in the image method according to the second embodiment;

FIG. 6 is a flow diagram showing the image processing method according to the third embodiment; and

FIG. 7 illustrates a transmitting system applicable in the image method according to the third embodiment.

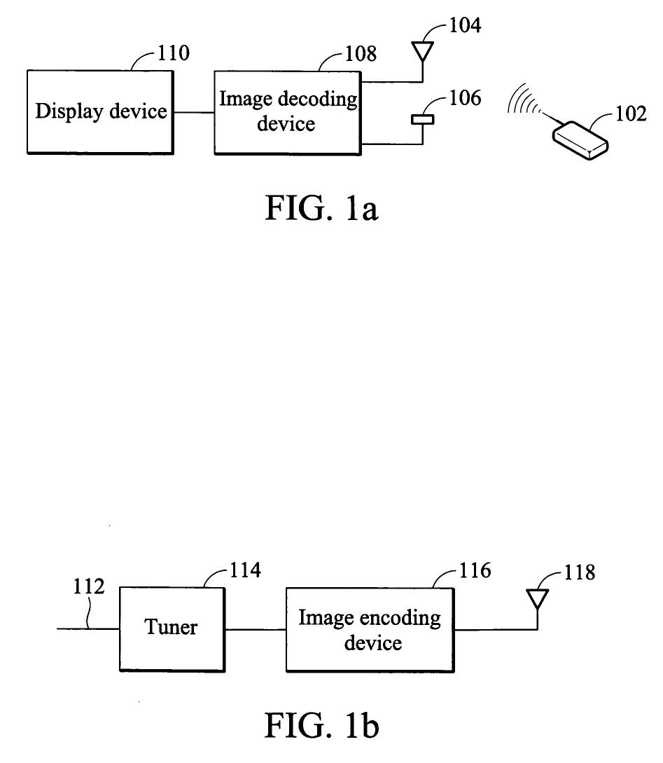

### DETAILED DESCRIPTION OF THE INVENTION

According to the invention, the image processing method is able to maintain the image display quality during a channel-conversion operation. In the following embodiments, a channel-conversion operation between a first channel and a second channel is given as an example, wherein different image signals, in the cases, a first image signal and a second image signal, are transmitted to a transmitting system from the two channels.

First Embodiment

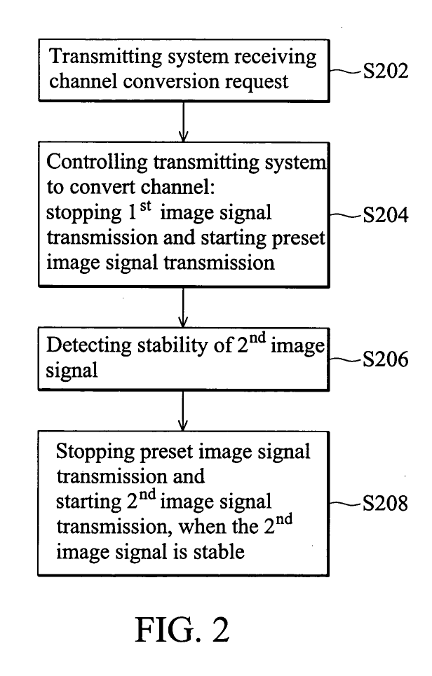

FIG. 2 is a flow diagram showing the image processing method according to the first embodiment. Before a channel conversion request is received by a transmitting system, the transmitting system digitizes the first image signal from the first channel, compressing the digitized first image signal, and transmitting the compressed digitized first image signal.

After the channel conversion request is received by the transmitting system (step S202), the inventive image processing method controls the transmitting system to begin channel conversion, the method comprising the steps of stopping transmission of the first image signal (including stopping compression of the digitized first image signal), and starting transmission of a preset image signal (step S204). The preset image signal has an image with a black background and a prompting string to prompt channel conversion.

Next, a detector is used to detect the stability of the second image signal of the second channel (step S206). When the second image signal is stable, it means that the second image signal is ready for channel conversion. The preset image signal stops transmitting, and the second image signal of the second channel starts transmitting (step S208). The step 208 further comprises the steps of digitizing the second image signal, compressing the digitized second image signal with a predetermined compression method, and transmitting the compressed digitized image signal by the transmitting system (not shown in FIG. 2).

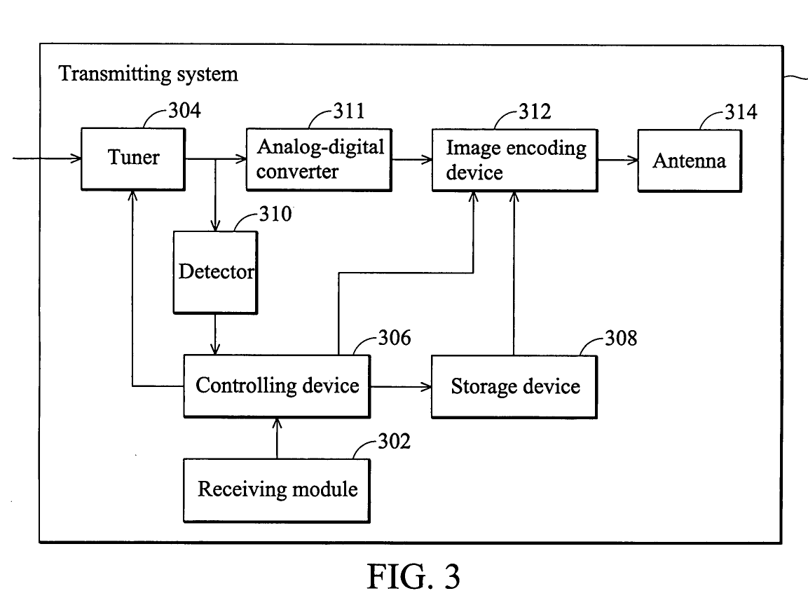

FIG. 3 illustrates a transmitting system applicable in the image method according to the first embodiment. The transmitting system comprises a receiving module 302, a tuner 304, a controlling device 306, a storage device 308, a detector 310, an analog-digital converter 311, an image encoding device 312 and an antenna 314.

The tuner 304 is for conversion between the first and the second channels. The channel conversion request signal may be sent from an infrared remote controller installed at a receiving terminal (not shown) or inside the transmitting system 300. When the tuner 304 selects the first channel, the first image signal of the first channel is transmitted to the analog-digital converter 311; accordingly, when the tuner 304 selects the second channel, the second image signal of the second channel is transmitted to the analog-digital converter 311.

The analog-digital converter 311 is used to digitize the first or second image signal. The image-encoding device 312 is used to compress the digitized first or second image signal by a predetermined compression method. The compressed digitized image signals are then output by the antenna 314. The predetermined compression method applied by the image encoding device 312 may involve a “group of pictures” technique, for example, the MPEG 4 compression method developed by the MEPG (Moving Picture Experts Group).

The storage device 308 is used to store the preset image signal. The preset image signal may be an image with a black background and have a prompting string to prompt channel conversion. The receiving module 302 is used to receive the request signal for channel conversion from an infrared remote controller (not shown). The request may also be received by the receiving terminal and then wirelessly transmitted to the transmitting system 300.

The controlling device 306, coupled to the receiving module 302, controls the tuner 304 to convert the channel according to the received request. Meanwhile, the controlling device 306 stops the image encoding device 312 from compressing the digitized first image signal and thereby stopping transmission of the first image signal. The controlling device 306 also controls the storage device 308 to transmit the preset image signal to the image encoding device 312. The image encoding device 312 then compresses the preset image signal and the compressed preset image signal is then output by the antenna 314.

During transmission of the digitized preset image signal, the detector 310 is used to detect the stability of the second image signal. When the second image signal is stable, the detector 310 informs the tuner 304 to begin channel conversion via the controlling device 306. Meanwhile, the detector 310 informs the controlling device 306 to stop transmitting the preset image signal, and the image encoding device 312 then stops compressing the preset image signal. The second image signal of the second channel starts transmitting. The controlling device 306 controls the image encoding device 312 to compress the digitized second image signal, and the compressed digitized second image signal is then transmitted by the antenna 314.

Second Embodiment

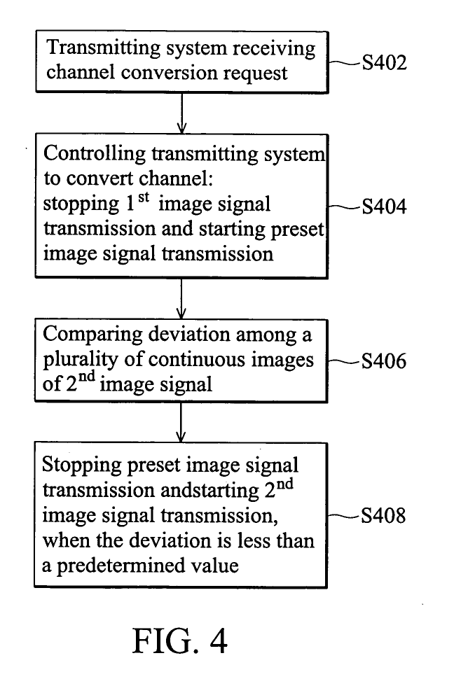

FIG. 4 is a flow diagram showing the image processing method according to the second embodiment. Before a channel conversion request is received by a transmitting system, the transmitting system digitizes the first image signal from the first channel, compressing the digitized first image signal, and transmitting the compressed digitized first image signal.

After the channel conversion request is received by the transmitting system (step S402), the inventive image processing method controls the transmitting system to begin channel conversion, the method comprising the steps of stopping transmission of the first image signal (including stopping compression of the digitized first image signal), and starting transmission of a preset image signal (step S404). The preset image signal has an image with a black background and a prompting string to prompt channel conversion.

Next, a comparator is used to compare the deviation among a plurality of continuous images of the second image signal (step S406). When the deviation is less than a predetermined value, it means that the second image signal is ready for channel conversion. The preset image signal stops transmitting, and the second image signal of the second channel starts transmitting (step S408). The step 408 further comprises the steps of digitizing the second image signal, compressing the digitized second image signal with a predetermined compression method, and transmitting the compressed digitized image signal by the transmitting system (not shown in FIG. 4).

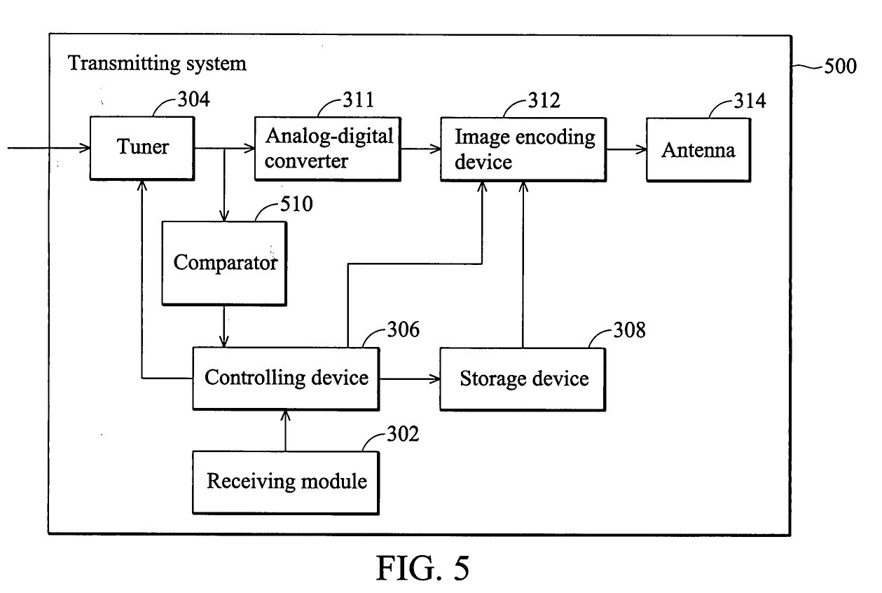

FIG. 5 illustrates a transmitting system applicable in the image method according to the second embodiment. Most of the devices of the transmitting system 500 perform the same functions as that of the transmitting system 300, while a comparator 510 is used instead of the detector 310. The corresponding devices of the transmitting system 500 have the same titles as that of the transmitting system 300.

During transmission of the digitized preset image signal, the comparator 510 receives a plurality of continuous digitized images of the second image signal from the analog-digital converter 311, and compares the deviation among the continuous images. When the deviation is less than a predetermined value, the comparator 510 informs the tuner 304 for channel conversion via the controlling device 306. Meanwhile, the comparator 510 informs the controlling device 306 to stop transmitting the preset image signal, and the image encoding device 312 stops compressing the preset image signal. The second image signal of the second channel starts transmitting. The controlling device 306 controls the image encoding device 312 to compress the digitized second image signal, and the compressed digitized second image signal is then transmitted by the antenna 314.

Third Embodiment

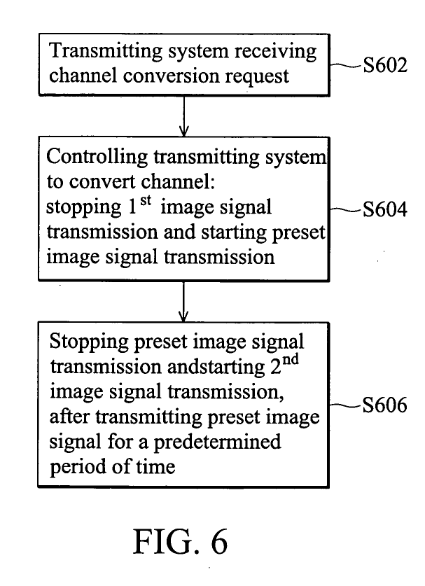

FIG. 6 is a flow diagram showing the image processing method according to the third embodiment.

Before a channel conversion request is received by a transmitting system, the transmitting system digitizes the first image signal from the first channel, compressing the digitized first image signal, and transmitting the compressed digitized first image signal.

After the channel conversion request is received by the transmitting system (step S602), the inventive image processing method controls the transmitting system to begin channel conversion, the method comprising the steps of stopping transmission of the first image signal (including stopping compression of the digitized first image signal), and starting transmission of a preset image signal (step S604). The preset image signal has an image with a black background and a prompting string to prompt channel conversion.

Next, after transmitting the preset image signal for a predetermined period of time, the preset image signal stops transmitting, and the second image signal of the second channel starts transmitting (step S606). The step 606 further comprises the steps of digitizing the second image signal, compressing the digitized second image signal with a predetermined compression method, and transmitting the compressed digitized image signal by the transmitting system (not shown in FIG. 6).

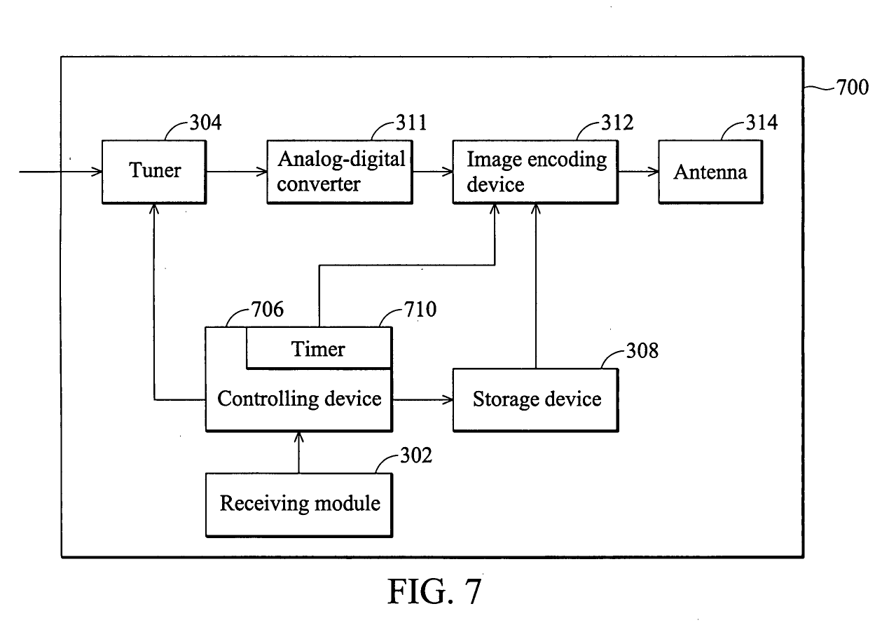

FIG. 7 illustrates a transmitting system applicable in the image method according to the third embodiment. Most of the devices of the transmitting system 700 perform the same functions as that of the transmitting system 300, while a timer 710 is used instead of the detector 310. The corresponding devices of the transmitting system 500 have the same titles as that of the transmitting system 300.

After the preset image signal has been transmitted for a predetermined period of time (the transmitting time of the preset image signal is counted by the timer 710), the preset image signal stops transmitting. Meanwhile, the controlling device 706 stops transmitting the preset image signal by controlling the image encoding device 312 to stop compressing the preset image signal. The second image signal of the second channel starts transmitting. The controlling device 706 controls the image encoding device 312 to compress the digitized second image signal, and the compressed digitized second image signal is then transmitted by the antenna 314.

According to the invention, the image display quality is ensured during a channel-conversion operation.

The foregoing description has been presented for purposes of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. An image processing method able to maintain the image display quality of a transmitting system during a channel conversion from a first channel to a second channel, wherein a first image signal and a second image signal are respectively transmitted to the transmitting system from the first channel and the second channel, comprising the steps of:
(A) sending a channel conversion request to the transmitting system;
(B) controlling the transmitting system to stop transmitting the first image signal and start to transmit a preset image signal; and
(C) stopping transmission of the preset image signal, and starting transmission of the second image signal.

2. The image processing method as claimed in claim 1, wherein the step (C) further comprises the steps of:
(D) determining whether the transmitting system is ready for the channel conversion from the first channel to the second channel; and
(E) if the transmitting system is ready for the channel conversion, stopping transmission of the preset image signal, and starting transmission of the second image signal.

3. The image processing method as claimed in claim 2, wherein the step (D) further comprises the step of:
(F) detecting the stability of the second image signal by a detector, and converting the channel from the first channel to the second channel after the second image signal is stable.

4. The image processing method as claimed in claim 2, wherein the step (D) further comprises the step of:
(G) comparing the deviation among a plurality of continuous images of the second image signal, and converting the channel from the first channel to the second channel after the deviation is less than a predetermined value.

5. The image processing method as claimed in claim 2, wherein the step (D) further comprises the step of:
(H) converting the channel from the first channel to the second channel after transmitting the preset image signal for a period of time.

6. The image processing method as claimed in claim 1, wherein the preset image signal has an image with a black background.

7. The image processing method as claimed in claim 6, wherein the image with a black background has a prompting string to prompt channel conversion.

8. The image processing method as claimed in claim 1 further comprises the steps of:
(I) digitizing the first image signal and compressing the digitized first image signal with a predetermined compression method by the transmitting system; and
(J) digitizing the second image signal and compressing the digitized second image signal with a predetermined compression method by the transmitting system.

9. The image processing method as claimed in claim 8, wherein the predetermined compression method involves a “group of pictures” technique.

10. The image processing method as claimed in claim 8, wherein the predetermined compression method is MPEG4 developed by the MEPG (Moving Picture Experts Group).

11. A transmitting system, comprising:
a receiving module for receiving a channel conversion request;
a tuner for channel conversion from a first channel to a second channel, wherein a first image signal and a second image signal are respectively transmitted to the transmitting system from the first channel and the second channel;
a controlling device to control the tuner for channel conversion according to the channel conversion request, stopping transmission of the first image signal and transmitting the preset image signal instead, and starting transmission of the second image signal after stopping transmission of the preset image signal; and
a storage device for storing the preset image signal.

12. The transmitting system as claimed in claim 11 further comprises a detector for detecting the stability of the second image signal, and the channel is converted from the first channel to the second channel after the second image signal is stable.

13. The transmitting system as claimed in claim 11 further comprises a comparator for comparing the deviation among a plurality of continuous images of the second image signal, and the channel is converted from the first channel to the second channel after the deviation is less than a predetermined value.

14. The transmitting system as claimed in claim 11 further comprises a timer for timing a period of time after starting transmitting the preset image signal, and the channel is converted from the first channel to the second channel after the period of time.

15. The transmitting system as claimed in claim 11, wherein the preset image signal has an image with a black background.

16. The transmitting system as claimed in claim 15, wherein the image with a black background has a prompting string to prompt channel conversion.

17. The transmitting system as claimed in claim 11, further comprises:
an analog-digital converter for digitizing the first image signal and the second image signal; and
an image encoding device for compressing the digitized first image signal and the second image signal by a predetermined compression method.

18. The transmitting system as claimed in claim 17, wherein the predetermined compression method involves a “group of pictures” technique.

19. The transmitting system as claimed in claim 17, wherein the predetermined compression method is MPEG4 developed by the MEPG (Moving Picture Experts Group).
